(19) United States
(12) Patent Application Publication
(10) Pub. No.: US 2004/0056930 A1
(43) Pub. Date: Mar. 25, 2004

(54) Piezoelectric ink jet print head and fabrication method for a vibrating layer thereof

(76) Inventors: Chih-Chang Tsai, Kaohsiung City (TW); Chen-Hua Lin, Douliou City (TW); Ming-Hsun Yang, Hsinchu (TW); Pao-Chi Chi, Dasi Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/653,566

(22) Filed: Sep. 2, 2003

(30) Foreign Application Priority Data
Sep. 23, 2002 (TW) 91121729

(51) Int. Cl. B41J 2/045

(52) U.S. Cl. 347/68

(57) ABSTRACT

A piezoelectric ink jet print head and a fabrication method for a vibrating layer thereof. An adhesion layer is formed between the bottom of a first silicon wafer and the top of a second silicon wafer for bonding thereof. The first silicon wafer serves as a vibrating layer, the second silicon wafer has a plurality of ink chambers spaced apart from each other, and the adhesion layer serves as an etching stop layer for the ink chambers. A piezoelectric material layer is formed on the top of the first silicon wafer, and a hard mask layer is formed on the bottom of the second silicon wafer for defining the pattern of the ink chambers.

### BACKGROUND OF THE INVENTION

1. Field of the Invention

The invention relates to a vibrating layer of a piezoelectric ink jet print head, and more particularly to a fabrication method with SOI (silicon-on-insulator), grinding and etching for a vibrating layer and an ink chamber of a piezoelectric ink jet print head.

2. Description of the Related Art

An ink jet print head is classified as a thermal bubble type or a piezoelectric type according to its primary working principle. The thermal bubble type employs a heater to vaporize ink droplets, and uses high-pressure bubbles to drive the ink droplets through the nozzle orifices, but has the problem of choosing suitable fluids for high-temperature gasification, causing limitations in application fields. The piezoelectric type employs a forced voltage to deform a piezoelectric ceramic body, and uses flexure displacement of the piezoelectric ceramic body to change the volume of a pressure-generating chamber, thus the chamber expels an ink droplet. The piezoelectric type has advantages as follows in comparison with the thermal bubble type. First, the piezoelectric ink jet print head has superior durability because the high-temperature gasification is omitted to avoid chemical variations. Second, the piezoelectric ink jet print head has a high-speed print performance because the piezoelectric ceramic body has quick response without the restriction of thermal conductivity. Third, the piezoelectric ink jet print head offers superior print quality because droplet volume is easily controlled.

The piezoelectric ink jet print head has been commercialized into a bend mode and a push mode according to the deformation mechanism of the piezoelectric body. Generally, the bend mode uses a face-shooter piezoelectric deformation, and the push mode uses an edge-shooter piezoelectric deformation.

FIG. 1 is a cross-section illustrating a conventional bend mode of the piezoelectric ink jet print head. The piezoelectric ink jet print head 10 comprises an actuator unit 12 and an ink path unit 14. The actuator unit 12 is a stack structure consisting of a multi-layered piezoelectric ceramic body 16, a vibrating plate 18, and a substrate 20, in which the substrate 20 has a plurality of pressure chambers 19 spaced apart from each other. The ink path unit 14 is a stack structure consisting of a first substrate 22, a second substrate 24 and a nozzle plate 26. The first substrate 22 has an ink slot 21 and an inlet/outlet hole 23, the second substrate 24 has an outlet path 25, and the nozzle plate 26 has a plurality of nozzle orifices 27. When a voltage is exerted by control circuits, the piezoelectric ceramic body 16 is deformed and impeded by the vibrating plate 18 to bend laterally, thus extruding the ink in the ink chamber 19. As a voltage difference arises between the internal space and the external circumference, the ink adjacent to the nozzle orifice 27 is accelerated and expelled as an ink droplet 28.

FIG. 2 is a cross-section illustrating a conventional push mode of the piezoelectric ink jet print head. The piezoelectric ink jet print head 30 comprises a single-layer piezoelectric ceramic plate 32, a transducer foot 34, a vibrating plate 36, a substrate 42 and a nozzle plate 44. The substrate 42 comprises an ink chamber 37, an ink slot 38, an inlet path 39 and an outlet path 40. The nozzle plate 44 comprises a plurality of nozzle orifices 43. Also, an electrode layer is formed on the sidewall of the ink chamber 37 by an electroless nickel plating method, and two electrodes are connected between three ink chambers 37. When the opposite potential of the applied voltage between the two electrodes is continuously increased, the ceramic sidewall of the ink chamber 37 bends outward to introduce ink. When the applied voltage is rapidly changed, the piezoelectric ceramic plate 32 is deformed to cause a greater bending motion, thus the ink in the ink chamber 37 is extruded by a right-hand thrust and expelled from the nozzle orifice 43 to form an ink droplet 46.

Conventionally, the vibrating plate and the ink chamber are formed by a laminated ceramic co-fired method which includes steps of synthesizing raw materials (such as PZT, ZrO₂, PbO, TiO₂ and other additives), mixing, drying, calcining, smashing, granulation, squeezing, shaping, sintering, and polarization. The complicated and difficult procedure of the laminated ceramic co-fired method, however, has disadvantages of low yield and high cost and is unfavorable to mass production. Accordingly, a modified method for forming the vibrating plate of the piezoelectric ink jet print head and increasing process reliability thereof is called for.

### SUMMARY OF THE INVENTION

Accordingly, an object of the present invention is to provide a fabrication method with SOI (silicon-on-insulator), grinding and etching for a vibrating layer and an ink chamber of a piezoelectric ink jet print head to solve the problems caused by the conventional method.

According to the object of the invention, a piezoelectric ink jet print head comprises a first silicon wafer serving as a vibrating layer; a second silicon wafer having a plurality of ink chambers spaced apart from each other, in which the top of the second silicon wafer adheres to the bottom of the first silicon wafer; an adhesion layer formed between the first silicon wafer and the second silicon wafer for bonding the second silicon wafer and the first silicon wafer, and serving as an etching stop layer for the ink chambers; a piezoelectric material layer formed on the top of the first silicon wafer; and a hard mask layer formed on the bottom of the second silicon wafer for defining the pattern of the ink chambers.

According to the object of the invention, a fabrication method for a vibrating layer of a piezoelectric ink jet print head, comprising steps of: providing a first silicon wafer and a second silicon wafer; providing an adhesion layer on the bottom of the first silicon wafer and on the top of the second silicon wafer; bonding the bottom of the first silicon wafer to the top of the second silicon wafer, in which the adhesion layer is formed between the first silicon wafer and the second silicon wafer; grinding the top of the first silicon wafer until the thickness of the first silicon wafer reaches 5˜20 μm, which serves as a vibrating layer; forming a hard mask layer on the bottom of the second silicon wafer, in which the hard mask layer comprises a plurality of openings for defining a pattern of ink chambers; and etching the second silicon wafer and using the adhesion layer as an etching stop layer, in which the second silicon wafer exposed within the opening are removed to form a plurality of ink chambers spaced apart from each other.

### DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section illustrating a conventional bend mode of the piezoelectric ink jet print head.

FIG. 2 is a cross-section illustrating a conventional push mode of the piezoelectric ink jet print head.

FIGS. 3A to 3F are cross-sections illustrating a method of forming a vibrating layer of a piezoelectric ink jet print head according to the first embodiment of the present invention.

FIGS. 4A to 4F are cross-sections illustrating a method of forming a vibrating layer of a piezoelectric ink jet print head according to the second embodiment of the present invention.

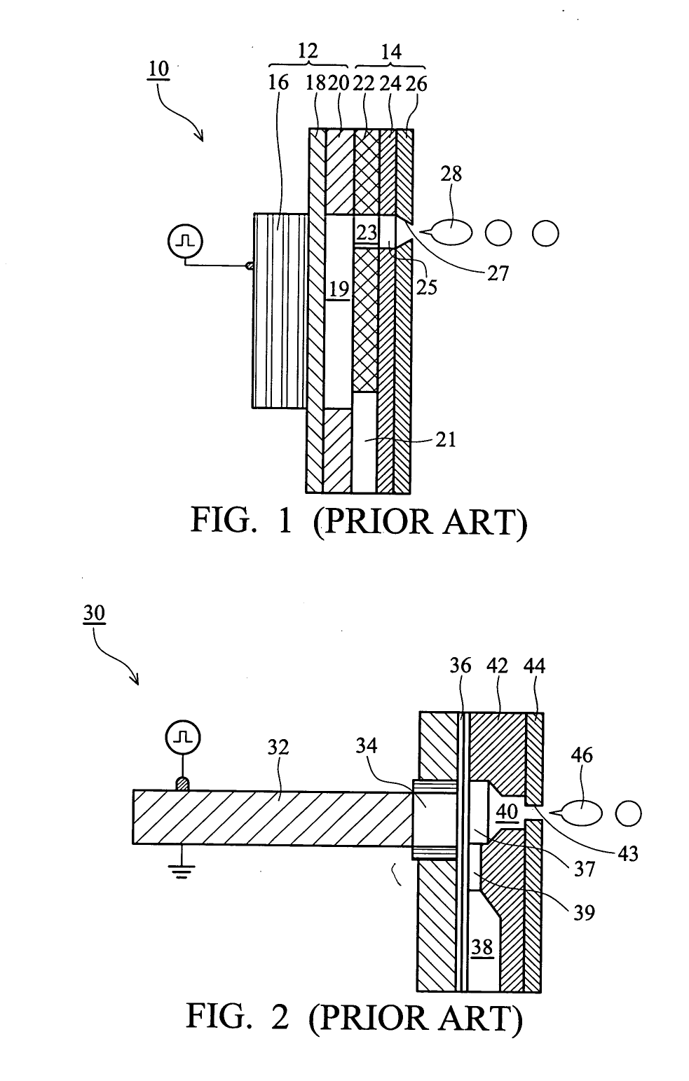

### DETAILED DESCRIPTION OF THE INVENTION

The present invention provides a vibrating layer of a piezoelectric ink jet print head and a fabrication method thereof. A SOI (silicon-on-insulator) technique and a grinding method are employed to form the main body of the piezoelectric ink jet print head, and then an etching process is employed to simultaneously complete a vibrating layer and an ink chamber. Preferably, the vibrating layer is composed of a silicon layer and a silicon oxide layer on a silicon wafer. The vibrating layer and the ink chamber are applied to a bend-mode piezoelectric ink jet print head or a push-mode piezoelectric ink jet print head.

### First Embodiment

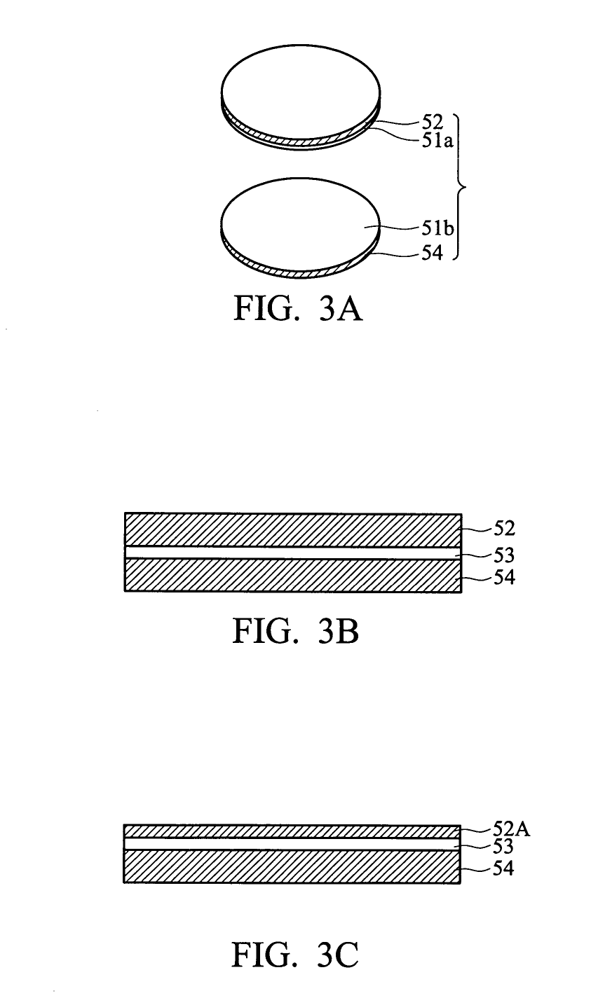

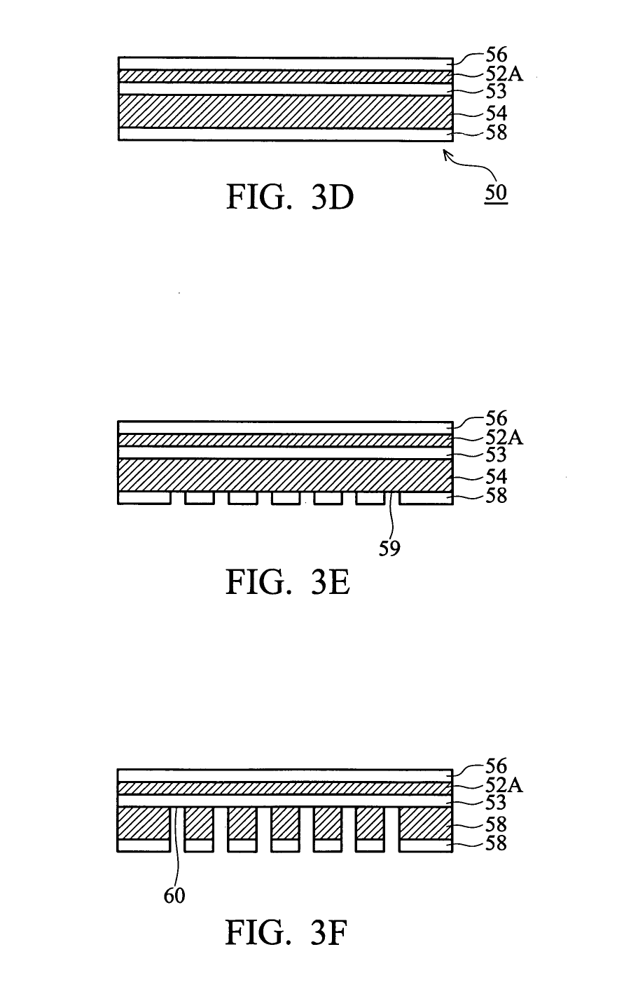

FIGS. 3A to 3F are cross-sections illustrating a method of forming a vibrating layer of a piezoelectric ink jet print head according to the first embodiment of the present invention.

In FIG. 3A, a first silicon wafer 52 and a second silicon wafer 54 are provided. Then, using an oxidation process, a first silicon oxide layer 51a is formed on a predetermined adhesion surface of the first silicon wafer 52, and a second silicon oxide layer 51b is formed on a predetermined adhesion surface of the second silicon wafer 54.

In FIG. 3B, using a SOI (silicon-on-insulator) technique, the bottom (the predetermined adhesion surface) of the first silicon wafer 52 is compactly adhered to the top (the predetermined adhesion surface) of the second silicon wafer 54. Preferably, using spin-on coating or spraying, a solution containing a hydrogen bond (such as acetone or alcohol) is formed on the predetermined adhesion surfaces of the first silicon wafer 52 and the second silicon wafer 54. Thus, the first silicon oxide layer 51a temporarily adheres to the second silicon oxide layer 51b to become a silicon oxide adhesion layer 53, which also serves as a stop layer 53 for a subsequent ink chamber process. Next, using a wafer alignment method and a wafer press method, the bottom of the first silicon wafer 52 is pressed downward to the top of the second silicon wafer 54.

In FIG. 3C, using a grinding process, such as a chemical mechanical polishing (CMP) method, the top of the first silicon wafer 52 is polished until its thickness reaches 5˜20 μm. Thus, the remaining portion of the first silicon wafer 52 serves as a vibrating layer 52A. Preferably, the silicon oxide layer adjacent to the bottom of the remaining portion of the first silicon wafer 52 also serves as a part of the vibrating layer 52A. At the same time, using a grinding process, such as a chemical mechanical polishing (CMP) method, the bottom of the second silicon wafer 54 is polished until its thickness reaches a predetermined depth for the subsequent ink chamber process.

In FIG. 3D, a piezoelectric material layer 56 is formed on the vibrating layer 52A, and then a sintering process is employed to complete the piezoelectric material layer 56 as a piezoelectric element. Alternatively, this sintering process can be performed after completing the subsequent ink chamber process. Next, a hard mask layer 58 is formed on the bottom of the second silicon wafer 54. Preferably, the hard mask layer 58 with a thickness of 5˜20 μm is a SiO₂ layer or a Si₃N₄ layer.

In FIG. 3E, using photolithography and etching, a plurality of openings 59 is formed in the hard mask layer 58 for defining a predetermined pattern of the ink chamber.

In FIG. 3F, using a dry etching process, a wet etching process or other enforceable methods from the bottom of the second silicon wafer 54, in which the hard mask layer 58 serves as a mask and the stop layer 53 serves as an etching stop layer for controlling the etching depth, the second silicon wafer 54 exposed within the openings 59 is removed to form a plurality of ink chambers 60 spaced apart from each other. Thereafter, processes for an ink slot, nozzle orifices and a nozzle plate will be performed under the ink chamber 60, which are omitted herein.

Compared with the conventional method, the present invention uses SOI, grinding, oxidation, photolithography and etching to form the remaining portion of the first silicon wafer 52 as the vibrating layer 52A, and uses etching from the bottom of the second silicon wafer 58 to form the ink chamber 60. Thus, the fabrication method of the vibrating layer 52A and the ink chamber 60 in the present invention can simplify procedures, reduce process difficulties, and increase process reliability, resulting in high yield, low cost and greater production.

### Second Embodiment

The fabrication method for a vibrating layer of a piezoelectric ink jet print head in the second embodiment is substantially similar to that of the first embodiment, with the similar portions omitted herein. The different portion is the wafer bonding method, in which an adhesion agent is used to replace the SOI technique so as to further simplify process steps and reduce process costs.

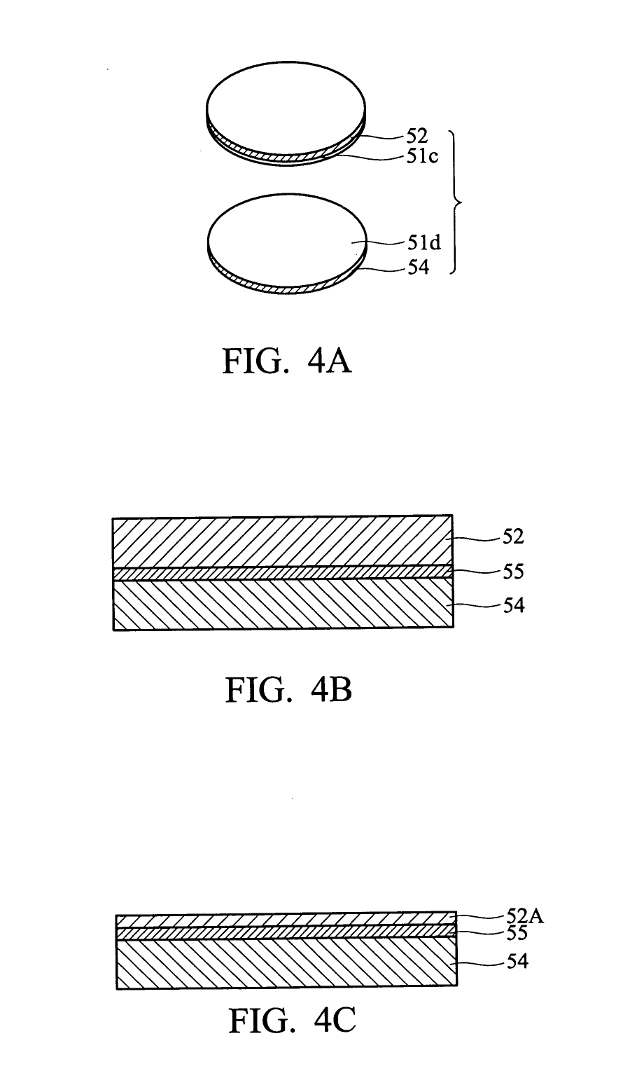

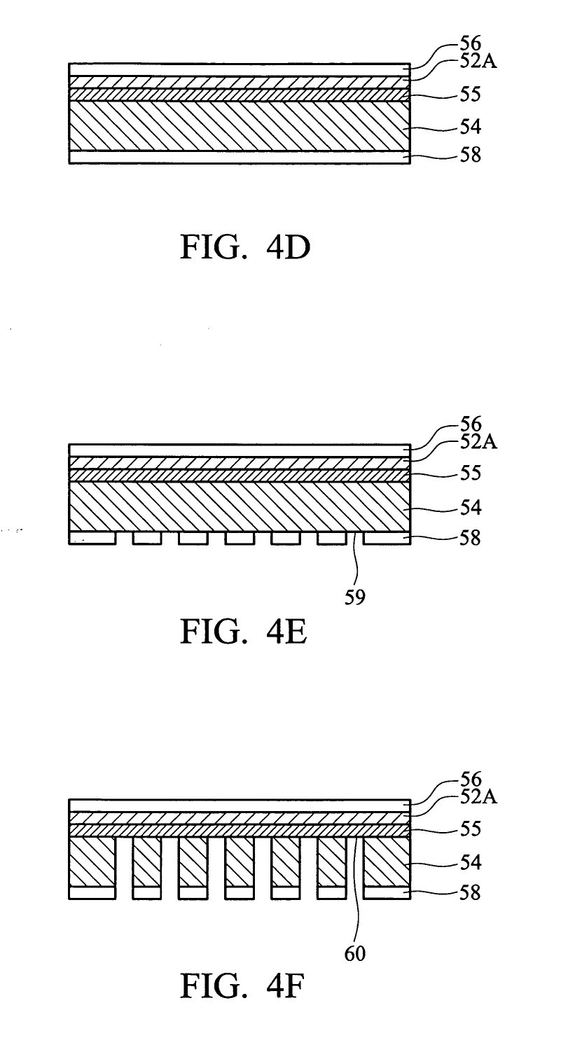

FIGS. 4A to 4F are cross-sections illustrating a method of forming a vibrating layer of a piezoelectric ink jet print head according to the second embodiment of the present invention.

In FIG. 4A, a first silicon wafer 52 and a second silicon wafer 54 are provided. Then, a first adhesion agent layer 51c is formed on a predetermined adhesion surface of the first silicon wafer 52, and a second adhesion agent layer 51d is formed on a predetermined adhesion surface of the second silicon wafer 54. Preferably, the first adhesion agent layer 51c and the second adhesion agent layer 51d are made of resin, PSG (phosphosilicate glass), SOG (spin on glass) or a dry film.

In FIG. 4B, the first adhesion agent layer 51c is compactly adhered to the second adhesion agent layer 51d to become an adhesion layer 55, thus the bottom (the predetermined adhesion surface) of the first silicon wafer 52 is temporarily adhered to the top (the predetermined adhesion surface) of the second silicon wafer 54. The adhesion layer 55 serves as a stop layer 55 for a subsequent ink chamber process. Next, using a wafer alignment method and a wafer press method, the bottom of the first silicon wafer 52 is pressed downward to the top of the second silicon wafer 54.

In FIG. 4C, using a grinding process, such as a chemical mechanical polishing (CMP) method, the top of the first silicon wafer 52 is polished until its thickness reaches 5˜20 μm. Thus, the remaining portion of the first silicon wafer 52 serves as a vibrating layer 52A. Preferably, the silicon oxide layer adjacent to the bottom of the remaining portion of the first silicon wafer 52 also serves as a part of the vibrating layer 52A. At the same time, using another grinding process, such as a chemical mechanical polishing (CMP) method, the bottom of the second silicon wafer 54 is polished until its thickness reaches a predetermined depth for the subsequent ink chamber process.

In FIG. 4D, a piezoelectric material layer 56 is formed on the vibrating layer 52A, and then a sintering process is employed to complete the piezoelectric material layer 56 as a piezoelectric element. Alternatively, this sintering process can be performed after completing the subsequent ink chamber process. Next, a hard mask layer 58 is formed on the bottom of the second silicon wafer 54. Preferably, the hard mask layer 58 with a thickness of 5˜20 μm is a SiO₂ layer or a Si₃N₄ layer.

In FIG. 4E, using photolithography and etching, a plurality of openings 59 is formed in the hard mask layer 58 for defining a predetermined pattern of the ink chamber.

In FIG. 4F, using a dry etching process, a wet etching process or other enforceable methods from the bottom of the second silicon wafer 54, in which the hard mask layer 58 serves as a mask and the stop layer 55 serves an etching stop layer for controlling the etching depth, the second silicon wafer 54 exposed within the openings 59 is removed to form a plurality of ink chambers 60 spaced apart from each other. Thereafter, processes for an ink slot, nozzle orifices and a nozzle plate will be performed under the ink chamber 60, which are omitted herein.

Compared with the conventional method, the present invention uses adhesion agent, grinding, oxidation, photolithography and etching to form the remaining portion of the first silicon wafer 52 as the vibrating layer 52A, and uses etching from the bottom of the second silicon wafer 58 to form the ink chambers 60. Thus, the fabrication method for the vibrating layer 52A and the ink chamber 60 in the present invention can simplify procedures, reduce process difficulties, and increase process reliability, resulting in high yield, low cost and greater production.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A piezoelectric ink jet print head, comprising:
a first silicon wafer serving as a vibrating layer;
a second silicon wafer having a plurality of ink chambers spaced apart from each other, in which the top of the second silicon wafer adheres to the bottom of the first silicon wafer;
an adhesion layer formed between the first silicon wafer and the second silicon wafer for bonding the second silicon wafer and the first silicon wafer, and serving as an etching stop layer for the ink chambers;
a piezoelectric material layer formed overlying the top of the first silicon wafer; and
a hard mask layer formed overlying the bottom of the second silicon wafer for defining the pattern of the ink chambers.

2. The piezoelectric ink jet print head as claimed in claim 1, wherein the thickness of the first silicon wafer is 5˜20 μm.

3. The piezoelectric ink jet print head as claimed in claim 1, wherein the adhesion between the second silicon wafer and the first silicon wafer is based on a SOI (silicon-on-insulator) technique.

4. The piezoelectric ink jet print head as claimed in claim 1, wherein the adhesion layer is a silicon oxide layer.

5. The piezoelectric ink jet print head as claimed in claim 1, wherein the adhesion layer is made of resin, PSG (phosphosilicate), SOG(spin on glass) or a dry film.

6. The piezoelectric ink jet print head as claimed in claim 1, wherein the hard mask layer is a silicon oxide layer.

7. The piezoelectric ink jet print head as claimed in claim 1, wherein the piezoelectric ink jet print head is a bend mode or a push mode.

8. A fabrication method for a vibrating layer of a piezoelectric ink jet print head, comprising steps of:
providing a first silicon wafer and a second silicon wafer;
providing an adhesion layer overlying the bottom of the first silicon wafer and overlying the top of the second silicon wafer;
bonding the bottom of the first silicon wafer to the top of the second silicon wafer, in which the adhesion layer is formed between the first silicon wafer and the second silicon wafer;
grinding the top of the first silicon wafer until the thickness of the first silicon wafer reaches 5˜20 μm, which serves as a vibrating layer;
forming a hard mask layer overlying the bottom of the second silicon wafer, in which the hard mask layer comprises a plurality of openings for defining a pattern of ink chambers; and
etching the second silicon wafer and using the adhesion layer as an etching stop layer, in which the second silicon wafer exposed within the opening are removed to form a plurality of ink chambers spaced apart from each other.

9. The fabrication method for a vibrating layer of a piezoelectric ink jet print head as claimed in claim 8, further comprising a step of forming a piezoelectric material layer overlying the top of the first silicon wafer.

10. The fabrication method for a vibrating layer of a piezoelectric ink jet print head as claimed in claim 8, before the formation of the hard mask layer, further comprising a step of grinding the second silicon wafer until the thickness of the second silicon wafer reaches a predetermined depth of the ink chamber.

11. The fabrication method for a vibrating layer of a piezoelectric ink jet print head as claimed in claim 8, wherein a SOI (silicon-on-insulator) technique is employed to bond the second silicon wafer and the first silicon wafer.

12. The fabrication method for a vibrating layer of a piezoelectric ink jet print head as claimed in claim 8, wherein the adhesion layer is a silicon oxide layer.

13. The fabrication method for a vibrating layer of a piezoelectric ink jet print head as claimed in claim 8, wherein the adhesion layer is made of resin, PSG (phosphosilicate), SOG(spin on glass) or a dry film.

14. The fabrication method for a vibrating layer of a piezoelectric ink jet print head as claimed in claim 8, wherein the hard mask layer is a silicon oxide layer.

15. The fabrication method for a vibrating layer of a piezoelectric ink jet print head as claimed in claim 8, wherein the grinding step uses a chemical mechanical polishing (CMP) method.

16. The fabrication method for a vibrating layer of a piezoelectric ink jet print head as claimed in claim 8, wherein the etching step uses a dry etching process or a wet etching process.

17. The fabrication method for a vibrating layer of a piezoelectric ink jet print head as claimed in claim 8, wherein the piezoelectric ink jet print head is a bend mode or a push mode.
